(19) United States
(12) Patent Application Publication
(10) Pub. No.: US 2015/0298888 A1
(43) Pub. Date: Oct. 22, 2015

(54) Protective Packaging for a Container

(71) Applicant: SANOFI-AVENTIS DEUTSCHLAND GMBH, Frankfurt (DE)

(72) Inventors: Bernd Kuhn, Frankfurt am Main (DE); Ernst-Josef Todt, Frankfurt am Main (DE)

(21) Appl. No.: 14/440,576

(22) PCT Filed: Nov. 5, 2013
(86) PCT No.: PCT/EP2013/072969

§ 371 Date: May 4, 2015

(30) Foreign Application Priority Data
Nov. 7, 2012 (EP) 12191586.2

(51) Int. Cl. B65D 81/30; B65D 75/52; A61J 1/00

(52) U.S. Cl. CPC B65D 81/30; A61J 1/00; B65D 75/522

(57) ABSTRACT

The present invention relates to a protective packaging for a container accommodating a light-sensitive substance, the packaging comprising: an opaque cover to completely enclose the container for transportation and/or storage in a sealed storage configuration, wherein the cover is transferable from said storage configuration into an application configuration by means of an opening structure which is adapted to provide access to at least one port structure of the container from outside the cover.

### CROSS REFERENCE TO RELATED APPLICATIONS

The present application is a U.S. National Phase Application pursuant to 35 U.S.C. §371 of International Application No. PCT/EP2013/072969 filed Nov. 5, 2013, which claims priority to European Patent Application No. 12191586.2 filed Nov. 7, 2012. The entire disclosure contents of these applications are herewith incorporated by reference into the present application.

### FIELD OF INVENTION

The present invention relates to a light-protective packaging for a container adapted to accommodate and/or to store a light-sensitive substance such like a medicament.

### BACKGROUND

Light-sensitive substances should be effectively protected against electromagnetic radiation. Therefore, such substances should be kept and stored in a dimmed or shaded environment. When exposed to electromagnetic radiation of a specific spectral range or wavelength, light-sensitive substances may be susceptible to a mechanical- or photo-chemical reaction, typically resulting in a degradation of the substance.

Providing the light-sensitive substance in an opaque container may provide an effective protection against electromagnetic radiation. However, application and/or administering of light-sensitive medicaments typically requires frequent visual inspection prior or during administering the medicament to a patient.

Document WO 01/56895 A2 discloses a light-protective container assembly comprising a translucent container defining an inner reservoir to contain a fluid and having a flexible sleeve connected to the container, wherein the sleeve is made of a material capable of substantially preventing the transmission of an identified range of wavelength of the electromagnetic spectrum. The sleeve is particularly designed for a flexible intravenous bag and is formed of a first sidewall and a second sidewall each having opposite lateral edge portions which can be bonded or sealed together to define a tubular structure to receive the flexible bag.

Moreover, the sleeve may be indirectly connected to the container by including at least one passageway through the container. The sleeve is then positioned on the container with one portion on one side of the container and with another portion on an opposite side of the container. First and second portions of the sleeve are then attached together, such as by a heat stake or by a fastening through the passageway of the container.

Visual inspection of the container disposed inside the sleeve requires that the sleeve has a completely opened lower end to allow the sleeve to be displaced relative to the container. Since the lower end of the sleeve is open, the sleeve itself cannot provide a hanger-like fastening of the container, e.g. to an infusion stand.

Moreover, the sleeve is only applicable during administering of the content of the container. For transportation and for storage of the container, an additional overwrap element is provided which upon use is to be torn open such that the connected combination of flexible bag, container and sleeve can be readily removed as a single, integral unit.

In another example as illustrated in FIG. 1, a notch 5 can be provided in an overwrap 2 to facilitate tearing away of an upper section of such a packaging 1. This way, the container 3 with a port structure 4 can be entirely removed from the packaging 1. In this configuration the outer packing 1 or overwrap element is discarded and the container 3 provided therein has to be protected either manually, e.g. by wrapping into a light-protecting overwrap or by making use of a separate opaque sleeve as for instance described in WO 01/56895 A2.

Usage of a light-protecting sleeve additional to an overwrap or outer packaging generates additional waste and makes the general use of such containers of infusion bags rather complicated. Moreover, the separate or combined use of an outer packaging together with a light-protecting sleeve may impose supplemental handling effort to medical staff, thereby lowering a level of acceptance to make proper use of such light-protecting means.

It is therefore an object of the present invention to provide an improved protective packaging for a container accommodating a light-sensitive substance, such like a medicament. The packaging should support waste reduction and should serve to simplify manufacturing, transportation and storage of such containers. Moreover, the protective packaging should provide an easy and intuitive handling of the container provided therein, in particular for administering the light-sensitive substance to a patient.

### SUMMARY

In a first aspect a protective packaging for a container accommodating a light-sensitive substance is provided. The packaging is adapted to wrap or to receive the container and comprises an opaque cover to completely enclose the container for the purpose of transporting and/or storing the same in a sealed storage configuration. Hence, the opaque cover is adapted to receive and to wrap the container in a sealed, preferably in a hermetically sealed configuration, such that the container is completely protected from the environment.

The cover is further transferable from the storage configuration, in which the container is completely wrapped therein, into an application configuration by means of an opening structure. The opening structure is adapted to provide access to at least one port structure of the container from outside the cover. This way access to the container can be provided without removing the container from the packaging.

In a practical application scenario, the container filled with the light-sensitive substance can be used without removal from the packaging and its opaque cover. Hence, for administering the light-sensitive substance to a patient, the container, e.g. in form of an infusion bag, may stay and remain inside the protective packaging even during use. Consequently, overall handling of the container can be simplified. Caregivers do no longer have to manually wrap the container into a separate light-protecting cover and a general level of acceptance to make use of the cover can be increased.

Moreover, since removal of the container from the packaging is no longer required for administering the medicament, the risk of exposing the light-sensitive substance to electromagnetic radiation can be effectively reduced.

The opaque cover is substantially non-transparent at least for electromagnetic radiation of a predefined spectral range. The spectral range for which the opaque cover is substantially non-transparent may be individually adapted in view of the substance provided in the container. If the substance would be only sensitive to a particular spectral range, then it would be sufficient that the opaque cover is substantially non-transparent for said specific spectral range. For residual spectral ranges outside said specific range the cover could be effectively translucent.

In a further embodiment, the opening structure is integrated into the cover and allows preparing at least one through opening of predetermined size into the cover. The opening structure is particularly adapted and operable to generate a through opening of limited size, which is just large enough for providing access to the at least one port structure of the container which remains inside the cover. Typically, the through opening to be created or to be constituted by the opening structure is much smaller than the geometry and dimensions of the container. Therefore, even by creating a through opening into the cover, the container with the light-sensitive substance substantially remains in a radiation-protected environment provided by the opaque cover.

It is of further benefit here, when the size of the through opening to be produced by the opening structure only allows receiving of a single or several port structures of the respective container. Preferably, the at least one port structure of the container may penetrate the through opening and may reach through the through opening outside the cover. In this way substantially unhindered access to the port structure can be provided thus allowing to connect the container with e.g. an infusion tube or with similar fluid guiding structures.

It is also conceivable, that the container comprises two or even more port structures, which may allow not only to withdraw a liquid substance from the container but also to introduce a liquid substance into the container if required. With two or even more port structures of the container it is not only conceivable that the opening structure is adapted to prepare a single through opening to receive the two or more support structures but that there exist several opening structures across the cover, which may individually provide access to at least one port structure, respectively.

In a further preferred embodiment, the cover comprises a receptacle section for the container and an extraction section for the at least one port structure of the container. Preferably, the port structure protrudes from the container and may therefore extend into the extraction section of the cover when the container is located in the adjacently arranged receptacle section. It is of particular benefit here, when the receptacle section and the extraction section are separated by at least one inwardly extending flange portion or by a bottleneck-like structure.

The flange portion may provide a kind of a bottleneck-like structure by way of which a removal of the container from the cover may be substantially prevented. The inwardly extending flange portion may be symmetrically or asymmetrically provided at opposite sidewalls of the opaque cover, thereby providing a through opening between oppositely arranged flange portions. The inwardly directed extension of the at least one flange portion is preferably such, that only the at least one or several port structures of the container may extend therethrough, such that a free end of respective port structures is located in the extraction section.

Preferably, in the storage configuration of the cover, the extraction section is sealed to the environment and is integrally formed with the cover and its receptacle section. In the application configuration however, the extraction section may be disintegrated and may be at least partially torn away in order to provide dedicated access to the least one port structure arranged therein. Since the extraction section is separated from the receptacle section by the at least one flange- or bottle neck portion, the container itself may still be sufficiently protected against electromagnetic radiation because the through opening between oppositely arranged flange portions through which the at least one port structure extends is sufficiently small.

In this particular embodiment, the opening structure may be exclusively provided in the region of the extraction section. In particular, the opening structure may comprise a structurally weakened portion such like a perforation or a score line, by way of which a free end of the extraction section facing away from the adjacently positioned receptacle section can be at least partially torn away.

Generally and according to another preferred embodiment, the opening structure may comprise a predetermined breaking structure integrated into or attached to the cover. By providing a predetermined breaking structure, e.g. in form of a perforation and/or score line, a well-defined through opening can be created in the opaque cover on demand for exclusively providing access to the at least one port structure of the container. Preferably, the opening structure is located at a predefined portion of the opaque cover, where also the at least one port structure of the container is located. In particular, the protective packaging provides a well-defined receptacle for the container such that its port structure substantially overlaps with the opening structure and/or with the through opening to be provided by said opening structure. In a further preferred embodiment, the opening structure is also operably engaged with the at least one port structure of the container. Upon wrapping or packing the container inside the protective packaging, the at least one port structure can be mechanically coupled with the opening structure of the opaque cover. This way, by means of activating the opening structure and by means of preparing and creating a respective through opening in the opaque cover, immediate access to the port structure may be given. In particular, the opening structure may provide a tear-off portion to be removed from or to be folded with respect to the opaque cover. By means of a respective coupling of the opening structure and the at least one port structure of the container, the port structure may be slaved by the opening structure in such a way, that by means of activating the opening structure the at least port structure automatically penetrates and reaches through the cover.

In still another aspect the cover further comprises at least one hanger. By means of the hanger, the opaque cover and hence the entire protective packaging with the container provided therein can be installed at an infusion stand. The hanger may comprise a through opening extending through the cover outside a receptacle section thereof. For instance, a respective hole or through opening may be provided in a circumferential seam so that penetration of the hanger by means of a hook does not harm the opaque cover for the container. Alternatively or additionally, the hanger may comprise a loop or a strap protruding from the opaque cover. Here, in a similar way, the closed loop or strap may be used to hang the protective packaging to an infusion stand.

Moreover, also the container itself may comprise a hanger, which may either be coupled to the opaque cover or which may at least partially extend through the opaque cover. This way, the protective packaging may be hung up by making use of a hanger of the container wrapped inside the opaque cover.

In a further preferred aspect, the cover comprises an inspection window being substantially translucent to electromagnetic radiation in the visible spectral range. The inspection window may be integrated into the cover and may be provided with a covering flap to provide visual inspection of the translucent container inside the protective packaging on demand. The inspection window preferably comprises a transparent material, such like a plastic foil or a transparent plastic material covering a through opening or cut out section of the remaining and residual opaque cover.

In a further preferred embodiment, the container typically prefilled with the light-sensitive substance is non-removably arranged inside the cover. In this context, a non-removable arrangement means that the container cannot be removed from the opaque cover without completely destroying or disintegrating the same. By keeping the container non-removably inside the opaque cover, misuse of the container and exposure of the container to inadmissible electromagnetic radiation can be effectively prevented.

In a further preferred aspect, the cover comprises a foil material, which in the storage configuration is completely and non-releasably sealed along its outer circumference. The foil material may comprise a flexible and bendable material. The cover may comprise a polymeric, elastomeric or metallic material in a one- or multilayer structure. Hence, the cover may comprise a polymeric and flexible material coated or laminated with a metal foil providing the desired optical transmission properties in view of electromagnetic radiation. It is also conceivable, that the cover exclusively comprises a metal foil, such like an aluminium foil. Moreover, the foil material may also be reinforced with a web or woven fabric.

The cover may be made of two separate sheets of foil material, wherein the container is arranged between an upper and a lower foil sheet sandwiching the container therebetween. By arranging said sheets in a substantially overlapping configuration, the outer circumference of the overlapping foil sheets can be sealed and non-releasably connected, e.g. by way of welding. This way, the container can be hermetically sealed inside the protective packaging. By sealing the foil material along its outer circumference, the container provided therein can be spatially fixed without directly applying heat to the container. Hence, the dimension of the opaque cover is preferably selected such, that there remains a free space between the outer circumference of the container and the sealed outer circumference of the opaque cover. This way, in the course of a sealing procedure of the opaque cover, direct application of heat to the container can be effectively circumvented.

Generally, the opaque cover does not necessarily have to be made of two separate sheets of a foil material. The cover may also be formed of a foil blank having two portions being folded on top of each other in a substantially overlapping configuration. The mutually overlapping circumference of the foil portions may then be sealed, e.g. by way of an appropriate heat treatment or by means of an appropriate adhesive.

In a further preferred embodiment, the opening structure may comprise a removable or foldable strap or tongue, which can be easily gripped by a user to provide access to a pre-configured through opening provided in the opaque cover underneath. Removing or folding away of the strap or tongue equally provides access to the port structure located underneath. The strap or tongue may either be integrally formed with the cover or may be provided as a separate item connected therewith. For instance, the strap or tongue may comprise a material being different to the material the opaque cover is made from. In particular, the strap or tongue may comprise an aluminium foil or a polymeric material initially covering and sealing a through opening in the opaque cover. Furthermore, the removable or foldable strap may be non-reuseably attached to the cover by means of an adhesive or by means of a bonded or welded connection thereby providing a tamper-evident closure.

In an alternative embodiment the opening structure comprises a removable twist-off cap or a screw cap. Correspondingly, the opaque cover then features a threaded socket to engage with such a cap. Here, the threaded socket may provide a kind of access opening. Typically, the socket is hollow and provides direct access to the interior of the opaque cover.

Additionally, the threaded socket may be provided with a removable seal, e.g. in form of a strap or a tongue, which may be made of a plastic material or a foil material, such like an aluminium foil.

In another embodiment, the cover is tightly wrapped around the container. The cover may also be press-fitted around the container. Especially, with flexible and deformable containers, such like infusion bags, a rather tight wrapping of the container inside the cover is beneficial in an application scenario, wherein the cover is attached to an infusion stand by means of its hanger. Additionally, a tight wrapping of the container by means of the cover only requires a minimum of covering material. Such a packaging is also beneficial in terms of saving packaging space. Moreover, by means of a tight wrapping of the container inside the cover a user may also haptically inspect the constitution and/or a filling level of the container. Touching of the cover tightly wrapping the container is immediately indicative of the container's filling level and/or of the mechanical constitution of the substance provided therein.

In another embodiment the cover is at least partially non-releasably connected with the container. A well-defined and immediate mutual interconnection of cover and container is beneficial when the container is to be hung up at an infusion stand by means of the cover only. The mutual interconnection of cover and container then serves to keep the container in a non-collapsing configuration for not hindering a flow of the light-sensitive substance. The partial interconnection of cover and container can be provided by selected welded spots or by means of an adhesive. Additionally or alternatively, a mutual interconnection of cover and container may also be attained by means of a positive interlocking of mutually corresponding positive interlock means of cover and container, respectively.

According to another embodiment the protective packaging including or comprises the container which is enclosed by the opaque cover. Here the container arranged inside the cover and enclosed by the opaque cover forms a part of the packaging or belongs to said packaging. Here, the protective packaging forms a packaging comprising the opaque cover and the container arranged therein.

In still another embodiment the container is at least partially filled with a liquid medicament. The container is typically of disposable type and is therefore intended for a one-time or single use only. Preferably, the container is filled with the liquid medicament in a mass-production process. The container filled with a liquid medicament typically serves as a primary packaging which is wrapped in the cover thereby acting as a secondary packaging. The cover and the protective packaging formed thereof is suitable to provide a sufficient light-protection or protection against electromagnetic radiation in a predefined spectral range during transportation and storage.

Upon use of the medicament the protective packaging and its opaque cover is only to be transferred from said storage configuration into the application configuration, in which access to the at least one port structure of the container is given. During application, the container typically remains completely inside the cover. A manual removal of the container from its secondary packaging is generally no longer required and the container can be effectively protected against electromagnetic radiation by a single cover and protective packaging over its whole lifecycle.

The term “drug” or “medicament”, as used herein, means a pharmaceutical formulation containing at least one pharmaceutically active compound,

wherein in one embodiment the pharmaceutically active compound has a molecular weight up to 1500 Da and/or is a peptide, a proteine, a polysaccharide, a vaccine, a DNA, a RNA, an enzyme, an antibody or a fragment thereof, a hormone or an oligonucleotide, or a mixture of the above-mentioned pharmaceutically active compound,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exendin-3 or exendin-4 or an analogue or derivative of exendin-3 or exendin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N-(N-palmitoyl-Y-glutamyl)-des(B30) human insulin; B29-N-(N-lithocholyl-Y-glutamyl)-des(B30) human insulin; B29-N-(ω-carboxyheptadecanoyl)-des(B30) human insulin and B29-N-(ω-carboxyheptadecanoyl) human insulin.

Exendin-4 for example means Exendin-4(1-39), a peptide of the sequence H-His-Gly-Glu-Gly-Thr-Phe-Thr-Ser-Asp-Leu-Ser-Lys-Gln-Met-Glu-Glu-Glu-Ala-Val-Arg-Leu-Phe-Ile-Glu-Trp-Leu-Lys-Asn-Gly-Gly-Pro-Ser-Ser-Gly-Ala-Pro-Pro-Pro-Ser-NH2.

Exendin-4 derivatives are for example selected from the following list of compounds:

H-(Lys)4-des Pro36, des Pro37 Exendin-4(1-39)-NH2,

H-(Lys)5-des Pro36, des Pro37 Exendin-4(1-39)-NH2,

des Pro36 Exendin-4(1-39),

des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39); or

des Pro36 [Asp28] Exendin-4(1-39),

des Pro36 [IsoAsp28] Exendin-4(1-39),

des Pro36 [Met(O)14, Asp28] Exendin-4(1-39),

des Pro36 [Met(O)14, IsoAsp28] Exendin-4(1-39),

des Pro36 [Trp(O2)25, Asp28] Exendin-4(1-39),

des Pro36 [Trp(O2)25, IsoAsp28] Exendin-4(1-39),

des Pro36 [Met(O)14 Trp(O2)25, Asp28] Exendin-4(1-39),

des Pro36 [Met(O)14 Trp(O2)25, IsoAsp28] Exendin-4(1-39),

wherein the group -Lys6-NH2 may be bound to the C-terminus of the Exendin-4 derivative;

or an Exendin-4 derivative of the sequence

des Pro36 Exendin-4(1-39)-Lys6-NH2 (AVE0010),

H-(Lys)6-des Pro36 [Asp28] Exendin-4(1-39)-Lys6-NH2,

des Asp28 Pro36, Pro37, Pro38Exendin-4(1-39)-NH2,

H-(Lys)6-des Pro36, Pro38 [Asp28] Exendin-4(1-39)-NH2,

H-Asn-(Glu)5des Pro36, Pro37, Pro38 [Asp28] Exendin-4(1-39)-NH2,

des Pro36, Pro37, Pro38 [Asp28] Exendin-4(1-39)-(Lys)6-NH2,

H-(Lys)6-des Pro36, Pro37, Pro38 [Asp28] Exendin-4(1-39)-(Lys)6-NH2,

H-Asn-(Glu)5-des Pro36, Pro37, Pro38 [Asp28] Exendin-4(1-39)-(Lys)6-NH2,

H-(Lys)6-des Pro36 [Trp(O2)25, Asp28] Exendin-4(1-39)-Lys6-NH2,

H-des Asp28 Pro36, Pro37, Pro38 [Trp(O2)25] Exendin-4(1-39)-NH2,

H-(Lys)6-des Pro36, Pro37, Pro38 [Trp(O2)25, Asp28] Exendin-4(1-39)-NH2,

H-Asn-(Glu)5-des Pro36, Pro37, Pro38 [Trp(O2)25, Asp28] Exendin-4(1-39)-NH2,

des Pro36, Pro37, Pro38 [Trp(O2)25, Asp28] Exendin-4(1-39)-(Lys)6-NH2,

H-(Lys)6-des Pro36, Pro37, Pro38 [Trp(O2)25, Asp28] Exendin-4(1-39)-(Lys)6-NH2,

H-Asn-(Glu)5-des Pro36, Pro37, Pro38 [Trp(O2)25, Asp28] Exendin-4(1-39)-(Lys)6-NH2,

H-(Lys)6-des Pro36 [Met(O)14, Asp28] Exendin-4(1-39)-Lys6-NH2,

des Met(O)14 Asp28 Pro36, Pro37, Pro38 Exendin-4(1-39)-NH2,

H-(Lys)6-desPro36, Pro37, Pro38 [Met(O)14, Asp28] Exendin-4(1-39)-NH2,

H-Asn-(Glu)5-des Pro36, Pro37, Pro38 [Met(O)14, Asp28] Exendin-4(1-39)-NH2,

des Pro36, Pro37, Pro38 [Met(O)14, Asp28] Exendin-4(1-39)-(Lys)6-NH2,

H-(Lys)6-des Pro36, Pro37, Pro38 [Met(O)14, Asp28] Exendin-4(1-39)-(Lys)6-NH2,

H-Asn-(Glu)5 des Pro36, Pro37, Pro38 [Met(O)14, Asp28] Exendin-4(1-39)-(Lys)6-NH2,

H-Lys6-des Pro36 [Met(O)14, Trp(O2)25, Asp28] Exendin-4(1-39)-Lys6-NH2,

H-des Asp28 Pro36, Pro37, Pro38 [Met(O)14, Trp(O2)25] Exendin-4(1-39)-NH2,

H-(Lys)6-des Pro36, Pro37, Pro38 [Met(O)14, Asp28] Exendin-4(1-39)-NH2,

H-Asn-(Glu)5-des Pro36, Pro37, Pro38 [Met(O)14, Trp(O2)25, Asp28] Exendin-4(1-39)-NH2,

des Pro36, Pro37, Pro38 [Met(O)14, Trp(O2)25, Asp28] Exendin-4(1-39)-(Lys)6-NH2,

H-(Lys)6-des Pro36, Pro37, Pro38 [Met(O)14, Trp(O2)25, Asp28] Exendin-4(S1-39)-(Lys)6-NH2,

H-Asn-(Glu)5-des Pro36, Pro37, Pro38 [Met(O)14, Trp(O2)25, Asp28] Exendin-4(1-39)-(Lys)6-NH2;

or a pharmaceutically acceptable salt or solvate of any one of the afore-mentioned Exendin-4 derivative.

Hormones are for example hypophysis hormones or hypothalamus hormones or regulatory active peptides and their antagonists as listed in Rote Liste, ed. 2008, Chapter 50, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Antibodies are globular plasma proteins (˜150 kDa) that are also known as immunoglobulins which share a basic structure. As they have sugar chains added to amino acid residues, they are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds between cysteine residues. Each heavy chain is about 440 amino acids long; each light chain is about 220 amino acids long. Heavy and light chains each contain intrachain disulfide bonds which stabilize their folding. Each chain is composed of structural domains called Ig domains. These domains contain about 70-110 amino acids and are classified into different categories (for example, variable or V, and constant or C) according to their size and function. They have a characteristic immunoglobulin fold in which two β sheets create a “sandwich” shape, held together by interactions between conserved cysteines and other charged amino acids.

There are five types of mammalian Ig heavy chain denoted by α, δ, ε, γ, and μ. The type of heavy chain present defines the isotype of antibody; these chains are found in IgA, IgD, IgE, IgG, and IgM antibodies, respectively.

Distinct heavy chains differ in size and composition; α and γ contain approximately 450 amino acids and δ approximately 500 amino acids, while μ and ε have approximately 550 amino acids. Each heavy chain has two regions, the constant region (C_{H}) and the variable region (V_{H}). In one species, the constant region is essentially identical in all antibodies of the same isotype, but differs in antibodies of different isotypes. Heavy chains γ, α and δ have a constant region composed of three tandem Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals, there are two types of immunoglobulin light chain denoted by λ and κ. A light chain has two successive domains: one constant domain (CL) and one variable domain (VL). The approximate length of a light chain is 211 to 217 amino acids. Each antibody contains two light chains that are always identical; only one type of light chain, κ or λ, is present per antibody in mammals.

Although the general structure of all antibodies is very similar, the unique property of a given antibody is determined by the variable (V) regions, as detailed above. More specifically, variable loops, three each the light (VL) and three on the heavy (VH) chain, are responsible for binding to the antigen, i.e. for its antigen specificity. These loops are referred to as the Complementarity Determining Regions (CDRs). Because CDRs from both VH and VL domains contribute to the antigen-binding site, it is the combination of the heavy and the light chains, and not either alone, that determines the final antigen specificity.

An “antibody fragment” contains at least one antigen binding fragment as defined above, and exhibits essentially the same function and specificity as the complete antibody of which the fragment is derived from. Limited proteolytic digestion with papain cleaves the Ig prototype into three fragments. Two identical amino terminal fragments, each containing one entire L chain and about half an H chain, are the antigen binding fragments (Fab). The third fragment, similar in size but containing the carboxyl terminal half of both heavy chains with their interchain disulfide bond, is the crystalizable fragment (Fc). The Fc contains carbohydrates, complement-binding, and FcR-binding sites. Limited pepsin digestion yields a single F(ab′)2 fragment containing both Fab pieces and the hinge region, including the H—H interchain disulfide bond. F(ab′)2 is divalent for antigen binding. The disulfide bond of F(ab′)2 may be cleaved in order to obtain Fab′. Moreover, the variable regions of the heavy and light chains can be fused together to form a single chain variable fragment (scFv).

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1-C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are for example hydrates.

It will be further apparent to those skilled in the art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following, various embodiments will be described by making reference to the drawings, in which:

FIG. 1 schematically illustrates a protective packaging according to the prior art,

FIG. 2 schematically illustrates a protective packaging according to a first embodiment,

FIG. 3 is indicative of an embodiment wherein the container comprises a two-fold port structure,

FIG. 4 shows a further embodiment of the packaging with a neck portion,

FIG. 5 illustrates another embodiment featuring an opening structure in form of a score line,

FIG. 6 shows another embodiment with a differently configured opening structure,

FIG. 7 shows an embodiment with a slit-like opening structure,

FIG. 8 illustrates a strap-based opening structure,

FIG. 9 shows an opening structure in an isolated illustration featuring a tongue,

FIG. 10 shows another opening structure with a screw cap,

FIG. 11 is indicative of a screw cap-type opening structure with an additional seal, and

FIG. 12 shows a screw cap-type opening structure comprising a cutting rim.

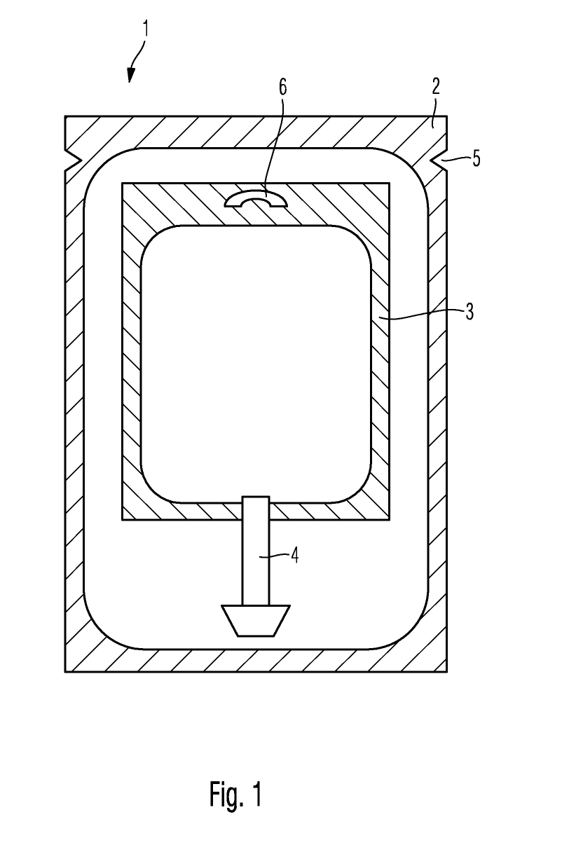

### DETAILED DESCRIPTION

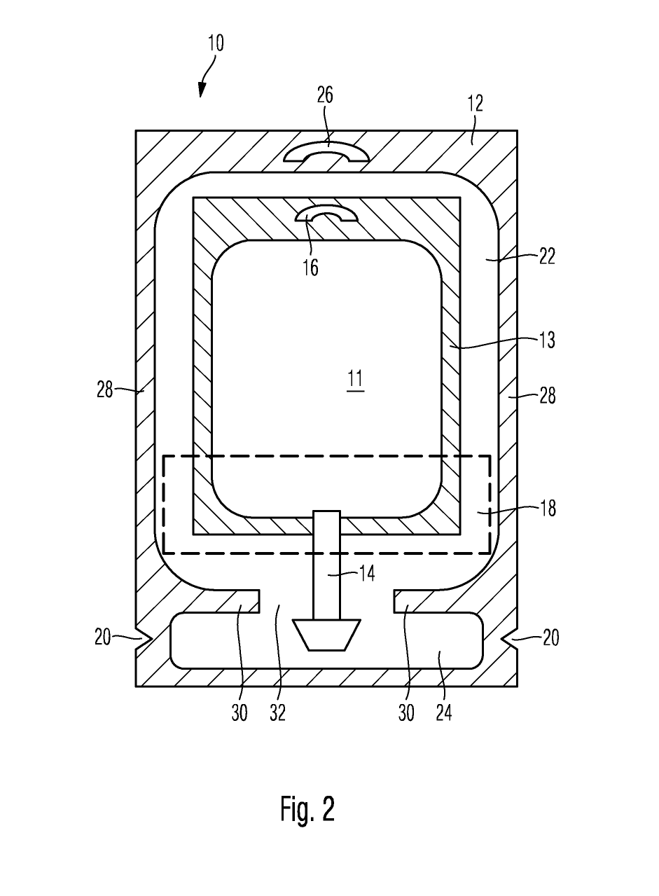

The protective packaging 10 as illustrated in FIG. 2 comprises an opaque bag-like cover 12 completely enclosing a bag-like container 13 which is filled with a light-sensitive substance 11, in particular with a light-sensitive medicament. While the container 13 might be substantially translucent in order to provide visual inspection of the substance 11 disposed therein, the protective packaging 10 and its opaque cover 12 are substantially non-transparent at least for a selected spectral range of electromagnetic radiation to which the substance 11 is rather sensitive.

The opaque cover 12 may comprise a flexible foil material, such like a non-transparent plastic foil and/or a metal foil being wrapped around the container 13. Here, it is also conceivable, that the cover 12 comprises a plastic layer laminated or coated with a non-transparent metal layer, or vice versa. The material the opaque cover 12 is made from may be flexible and mechanically deformable. It may also be stretchable to a predefined extent to enable a tight fitting of the container 13 and the cover 12.

The cover 12 comprises at least one substantially transparent or translucent inspection window 18 which at least partially overlaps with the position of the container 13 and its interior space accommodating the substance 11. The inspection window 18 is preferably provided with an opaque flap adapted to entirely cover the inspection window 18. The flap, which is not particularly illustrated here, thus serves to entirely protect the inner volume of the opaque cover 12 from external electromagnetic radiation. By means of the inspection window 18, not only a filling level of the container 13 but also the constitution and appearance of the substance 11 disposed therein can be at least visually inspected prior to an application.

As further illustrated in FIG. 2, the container 13 comprises a port structure 14 which is to be connected with a tubing or with some other kind of administering- or substance delivering means. The port structure 14 may comprise a well-defined and standardized interconnection means, such like a luer connector. As shown in FIG. 2, also the port structure 14 is entirely wrapped inside the opaque cover 12. However, a distal end of the port structure 14 facing away from the container 13 extends into an extraction section 24 of the cover 12 which is separated from the residual cover by two oppositely disposed and inwardly extending flange portions 30.

By means of the flange portions 30, the inner volume of the opaque cover 12 can be split into said extraction section 24 and into a receptacle section 22 which is adapted to receive and to keep the container 13 therein. In other words, the port structure 14 just extends through a neck portion or through opening 32 formed between the inward facing free ends of the oppositely disposed flange portions 30.

Furthermore, the cover 12 comprises an opening structure 20 at its lateral and opposite sides, especially in a region of the extraction section 24. In this way, the cover may be ripped open and the extraction section 24 may be at least partially torn off in order to give access to the downward facing and distal portion of the illustrated port structure 14. Due to the limited size of the through opening 32, the container 13 is still effectively protected against electromagnetic radiation in the application configuration while only the port structure 14 is accessible from outside the opaque cover 12.

Here, the opening structure 20 provides a predetermined breaking structure to separate and to open the opaque cover. For instance, the opening structure 20 may comprise a predetermined structural weakening, e.g. in form of a perforation or a score line. The opening structure 20 may also comprise or define a notch.

Preferably, the size of the opening 32 is adapted to the dimensions and extension of the port structure 14. In preferred embodiments, the size of the through opening 32 is selected such, that the port structure 14 just extends there through. Hence, the clear opening 32 between the oppositely located flange portions 30 may directly correspond to the outer diameter of the port structure 14. It may be substantially equal to said outer diameter.

The protective packaging 10 and the opaque cover 12 further comprise a circumferential seam or seal 28 extending all around the cover 12. By sealing all outer and circumferential edges of the cover 12, the cover 12 may serve as a secondary packaging for transportation and storage of the container 13.

As further illustrated in FIG. 2, the circumferential seam 28 may be located at a certain distance from an outer circumference of the container 13. When the container 13 is wrapped in the opaque cover 12, e.g. in a mass-production process and when substantially overlapping outer edge portions of the opaque cover 12 are sealed, e.g. by applying heat in the course of a welding procedure, keeping of a predefined distance between the seal 28 and the outer edge of the container 13 can be beneficial to avoid application of heat to the container 13.

Additionally, the cover 12 comprises a hanger 26 at an upper portion, which is located at an opposite end compared to the extraction section 24. By means of the hanger 26, the protective packaging 10 can be mounted to a support structure, e.g. to an infusion stand. Especially when tightly wrapped inside the opaque cover 12, the container 13 will not be able to deform when the protective packaging 10 is installed at such a support structure. Additionally but not illustrated here, the container 13 may be at least partially and non-releasably interconnected with the cover 12 for suppressing and effectively preventing an unintended deformation or displacement of the container 13 with respect to the cover 12.

Additionally, also the container 13 itself may comprise a hanger 16 by way of which the container 13 and the protective packaging 10 may be hung up. For this purpose, an additional but not illustrated opening structure may be provided in the opaque cover 12 in order to allow penetration of the cover 12 by the hanger 16 of the container 13.

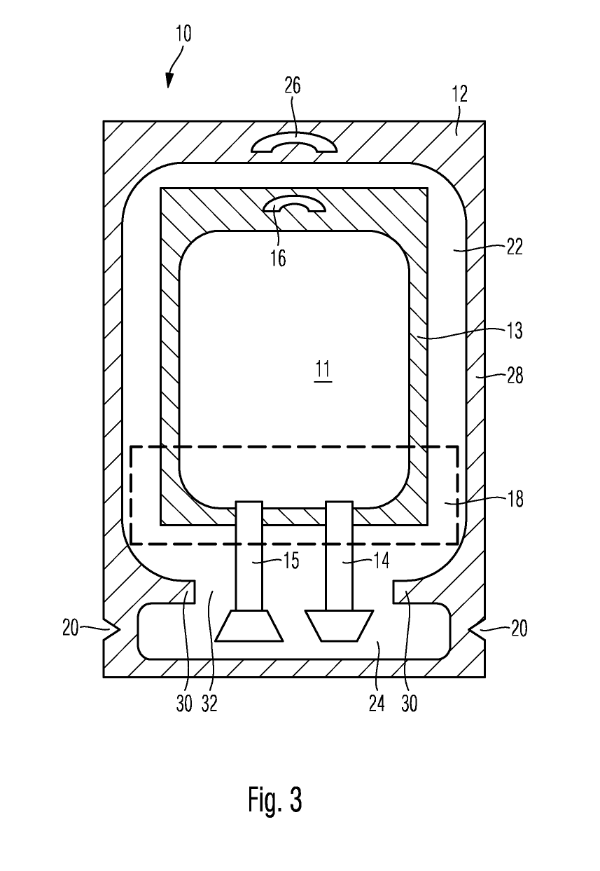

The various additional and alternative embodiment as illustrated in FIGS. 3 to 7 are rather similar to the embodiment as shown in FIG. 2. Identical or similar features and components are therefore indicated with the same or like reference numerals. In the following, only particular differences between the embodiments of FIGS. 3 to 7 are described in comparison to the embodiment according to FIG. 2.

The embodiment as illustrated in FIG. 3 differs from the one in FIG. 2 in that the container 13 comprises two port structures 14, 15 both extending into the extraction section 24 of the cover 12. Here, one of the port structures, e.g. the port structure 15 may serve to inject a solvent into the interior of the container 13 while the other port structure 14 allows to extract a corresponding liquid substance 11 therefrom.

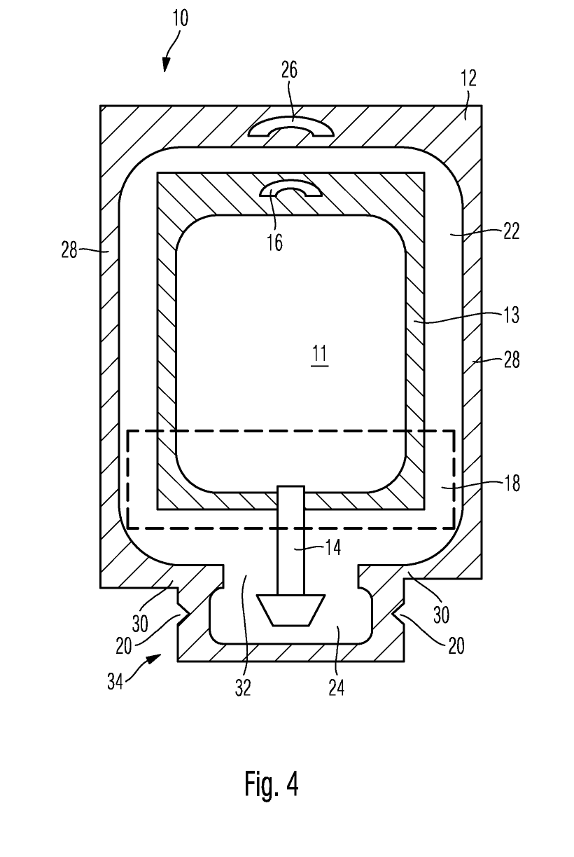

In the further embodiment according to FIG. 4, the outer shape of the cover 12 differs slightly from the cover 12 as shown in FIGS. 2 and 3. Here, the extraction section 24 is reduced in its lateral size and only encloses the distal end of the port structure 14. The inwardly extending and oppositely located flange portions 30 form an outer edge of the packaging 10, so that the extraction section 24 forms a neck portion 34 substantially resembling a bottle neck structure. In other words, the extraction section 24 and the neck portion 34 form a protruding portion extending from a lower edge of the packaging 10.

With this embodiment, the opening structure 20 is immediately visible already from the outer geometry and the outer silhouette of the packaging 10. Moreover and compared to the embodiments as shown in FIGS. 2 and 3, less material is required for the packaging 10 and its over 12.

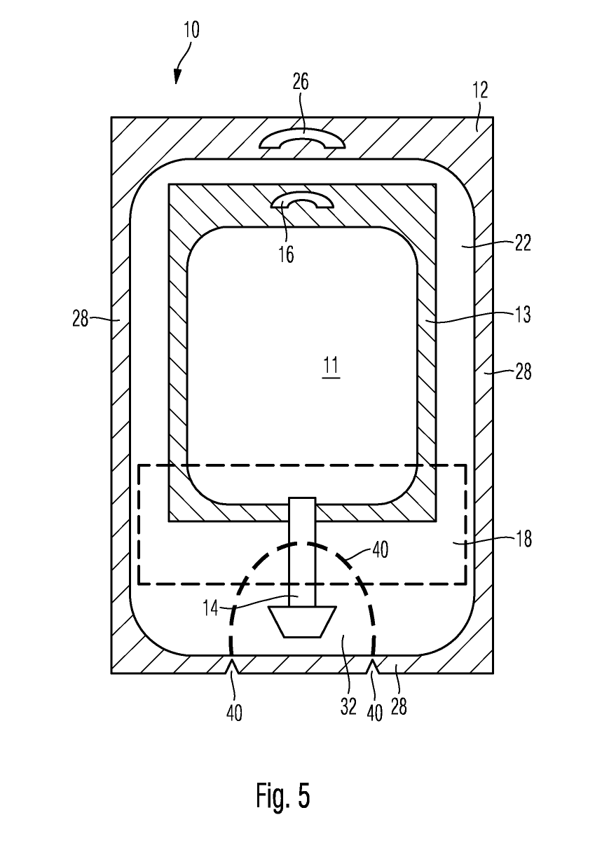

In the embodiment according to FIG. 5, a different opening structure 40 is implemented. Here, the opening structure 40 comprises a circular shaped score line or a respective weakening structure extending into the lower edge of the cover 12. Here, only a section of the lower edge of the circumferential seal 28 can be torn away or at least partially stripped off in a well-defined way as specified by the score line 40. If ripped or torn away, the port structure 14 may extend into a semi-circular shaped recess forming a respective through opening 32.

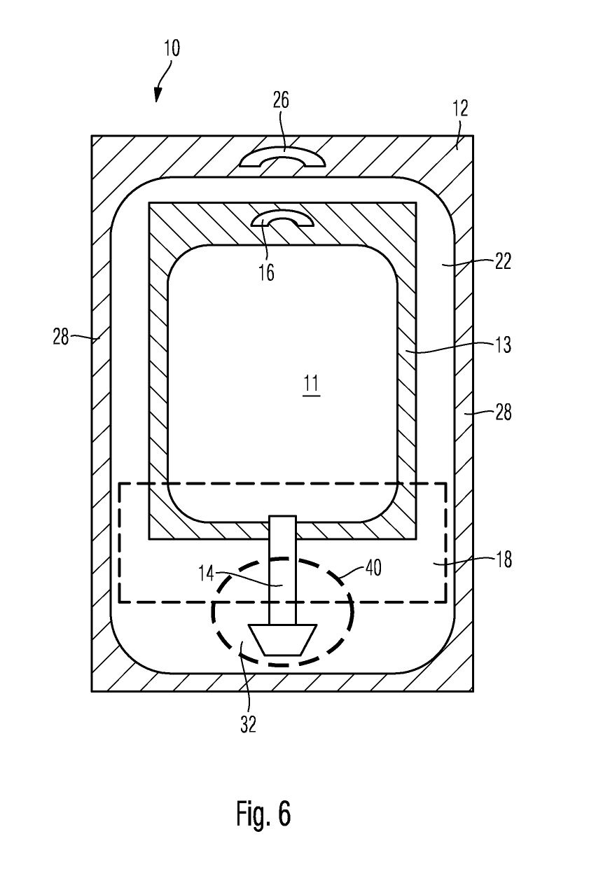

From a functional point of view, the embodiment according to FIG. 6 substantially resembles the one as shown in FIG. 5. But here, the opening structure 40 does not extend into the circumferential seal 28 but remains at a certain distance therefrom. Moreover, the opening structure 40 is of substantially circular shape but it may also be substantially quadratic, rectangular or oval shaped. The opening structure 40 provides a score line or a structurally weakened portion allowing to tear away or to at least partially tear-off a portion of the cover 12 in order to provide access to the port structure 14.

In preferred embodiments, the opening structure 40 supports only a partial removal of a cover portion so as to provide a flap upon transferring the cover 12 from its closed storage configuration into the application configuration. This way, the port structure 14 may only be accessible via the through opening 32 while a loosened flap substantially covers the through opening 32 after or during interconnecting the port structure 14 with a substance guiding tube or the like. It is to be noted here, that generation of such a flap is by no way limited to the embodiment as shown in FIG. 6 but may be optionally provided with any other described or illustrated embodiment.

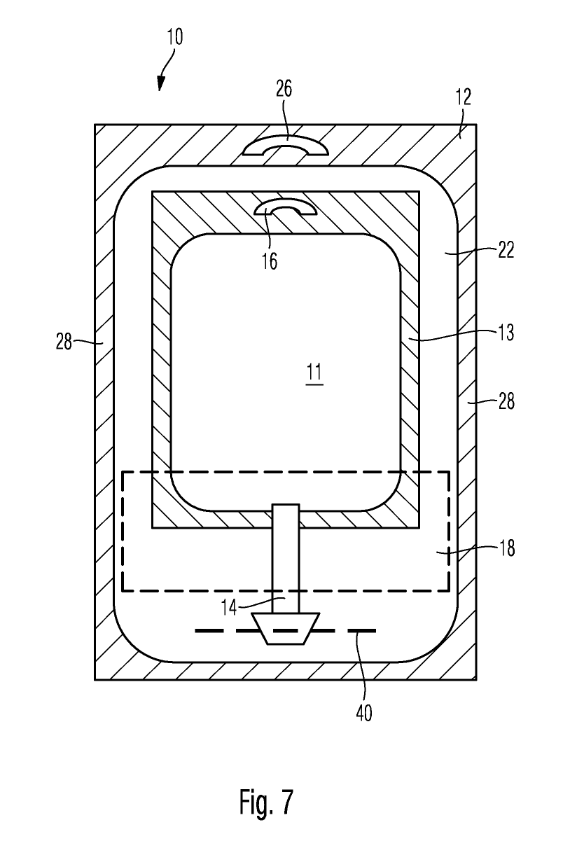

In the further embodiment according to FIG. 7, the opening structure 40 provides a slit. Accordingly, the opening structure 40 then comprises a rather straight or bended score line or perforation. Here, the size of a through opening 32 to be formed by the opening structure 40 is comparatively small for effectively reducing the amount of light entering the cover 12.

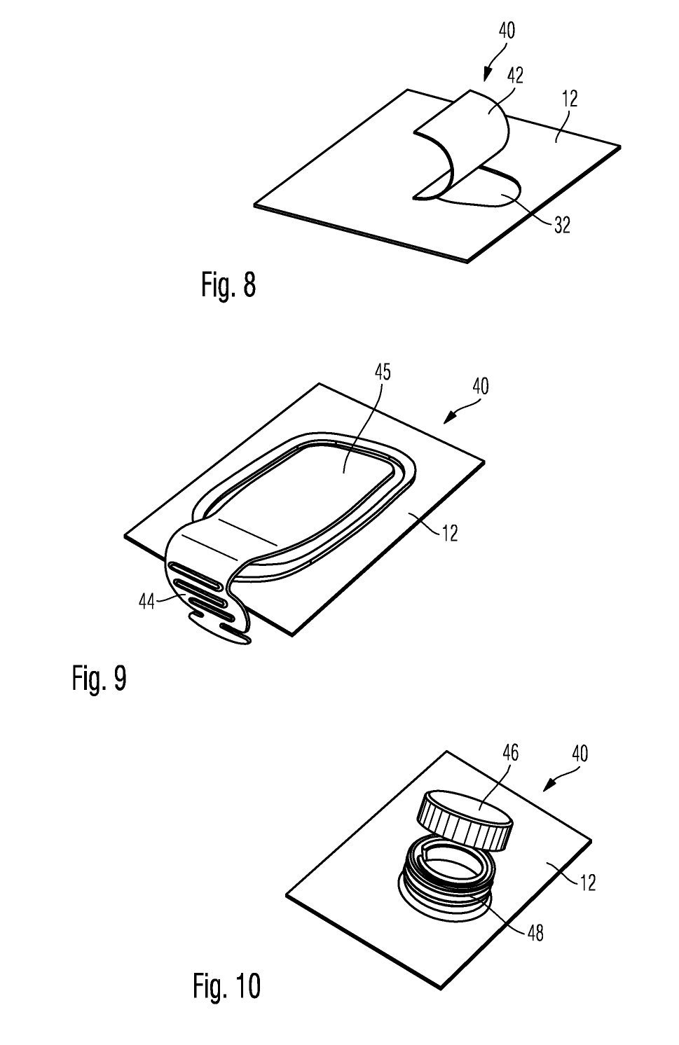

FIGS. 8 to 12 show various different kinds of opening structures 40, which may be used and which may be integrated in at least one sidewall of the cover in order to provide access to the port structure 14 of the container 13 located therein. As shown in FIG. 8, the opening structure 40 may comprise a tear-off strap 42, which may either be integrally formed with the material of the cover 12 or which may be provided as a separate piece to be at least partially torn away or stripped off. The strap 42 may for instance be welded or seamed with the surrounding cover 12 featuring a through opening 32 readily disposed therein.

The strap 42 as shown in FIG. 8 may comprise an aluminium or plastic foil, typically provided with a not separately illustrated lifting portion at its free end allowing for an easy and intuitive gripping of the strap 42.

In FIG. 9, a different embodiment of an opening structure 40 is illustrated. Here, the opening structure 40 comprises a plastic tongue 44, which may be gripped to open a lid-like cover portion 45 of the opening structure 40. Also here, the cover portion 45 may cover a predefined through opening 32 provided in the cover 12.

FIG. 10 is further illustrative of an opening structure 40 comprising a removable screw cap 46. As shown here, the cover 12 is provided with or comprises a threaded socket 48 protruding from the substantially flat surface of the cover 12. The hollow threaded socket 48 provides direct access to the inner volume of the cover 12. By removing the screw cap 46, e.g. by a respective screwing or twisting motion, access to the interior of the cover 12 may be immediately given. Additionally, but not illustrated here, the threaded socket 48 may be provided with a removable or breakable and hence tamper-evident seal.

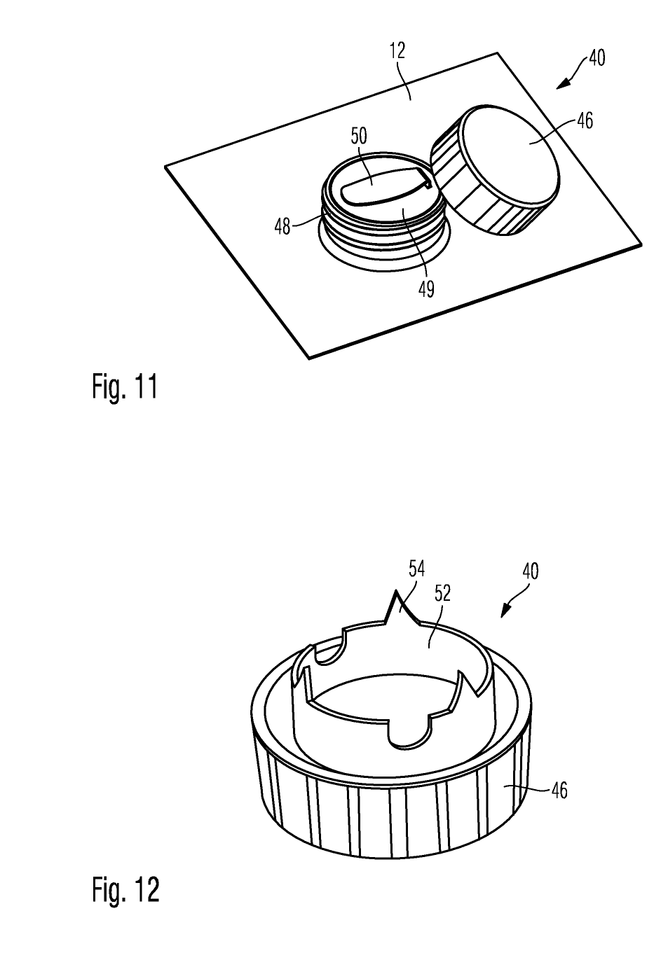

In FIG. 11, a further embodiment of a screw cap-based opening structure 40 is illustrated. Here, the threaded socket 48 is provided with an additional seal 49 having a strap portion 50, which is to be gripped and removed by a user for gaining access to the interior of the cover 12. The strap portion 50 may be integrally formed with the seal 49, which in turn may also be integrally formed with the threaded socket 48.

In FIG. 12, an alternative or supplemental embodiment of a screw cap 46 is illustrated. Here and in contrast to the illustrations according to FIGS. 10 and 11 the screw cap 46 is illustrated upside down. As shown there, the screw cap 46 is additionally provided with a cutting rim 52 having various peaks 54. Such a cutting rim 52 is particularly applicable with threaded sockets 48 being sealed with a destroyable seal, such like a plastic- or aluminium foil. Then, simply by turning the screw cap 46, the seal of the corresponding threaded socket 48 can be immediately broken so as to provide access to the interior of the cover 12.

Even though not particularly illustrated it is of particular benefit, when the at least one port structure 14, 15 of the container 13 is somehow mechanically coupled with at least one of the conceivable opening structures 20, 40. In this way, activating the opening structure may immediately provide access to the port structure 14, 15 and/or may even support and an at least partial removal of the respective port structure 14, 15 from the cover 12.

1-16. (canceled)

17. A protective packaging for a container accommodating a light-sensitive substance, the packaging comprising:
an opaque cover to completely enclose the container for transportation and/or storage in a sealed storage configuration,
wherein the cover is transferable from said storage configuration into an application configuration by means of an opening structure which is adapted to provide access to at least one port structure of the container from outside the cover.

18. The protective packaging according to claim 17, wherein the opening structure is integrated into the cover and allows to prepare at least one through opening (32) of predetermined size into the cover.

19. The protective packaging to claim 18, wherein the size of the through opening only allows to receive a single or several port structures of the container.

20. The protective packaging according to claim 17, wherein the cover comprises a receptacle section for the container and an extraction section for the least one port structure of the container, wherein the receptacle section and the extraction section are separated by at least one inwardly extending flange portion.

21. The protective packaging according to claim 17, wherein the opening structure comprises a predetermined breaking structure integrated into the cover.

22. The protective packaging according to claim 17, wherein the opening structure is operably engaged with the at least one port structure of the container.

23. The protective packaging according to claim 17, wherein the cover further comprises at least one hanger.

24. The protective packaging according to claim 17, wherein the cover comprises an inspection window.

25. The protective packaging according to claim 17, wherein the container filled with a the substance is non-removably arranged inside the cover.

26. The protective packaging according to claim 17, wherein the cover comprises a foil material, which in the storage configuration is completely and non-releasably sealed along its outer circumference.

27. The protective packaging according to claim 17, wherein the opening structure comprises a removable or foldable strap or tongue.

28. The protective packaging according to claim 17, wherein the opening structure comprises a removable twist-off cap or screw cap.

29. The protective packaging according to claim 17, wherein the cover is tightly wrapped around the container.

30. The protective packaging according to claim 17, wherein the cover is at least partially non-releasably connected with the container.

31. The protective packaging according to claim 17 further including the container enclosed by the opaque cover.

32. The protective packaging according to claim 17, wherein the container is at least partially filled with a liquid medicament.
